(19) United States
(12) Patent Application Publication
(10) Pub. No.: US 2009/0143112 A1
(43) Pub. Date: Jun. 4, 2009

(54) Battery and mobile communication apparatus including the same

(75) Inventors: Chia-Wei Jao, Taipei (TW); Chu-Ming Wu, Taipei (TW); Yan-Wen Chen, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/292,938

(22) Filed: Dec. 1, 2008

(30) Foreign Application Priority Data
Nov. 30, 2007 (TW) 096145514

(51) Int. Cl. H04M 1/00

(52) U.S. Cl. 455/572

(57) ABSTRACT

The invention discloses a battery configured in a mobile communication apparatus. The battery comprises a contacting portion and a connecting portion. The contacting portion comprises a plurality of first conductive terminals for electrically contacting to an information component. The connecting portion comprises a plurality of second conductive terminals for electrically contacting to the mobile communication apparatus, wherein at least one part of the second conductive terminals connects to the first conductive terminals to enable the information component to transmit a signal to the mobile communication apparatus through the first conductive terminals and the at least one part of the second conductive terminals. Accordingly, the mobile communication apparatus and the information component are protected from damage, and the thickness of the mobile communication apparatus will not be limited by the information component connector.

### BACKGROUND OF THE INVENTION

1. Field of the invention

The invention relates to a battery and a mobile communication apparatus including the battery, and more particularly, the invention relates to a battery used in a mobile communication apparatus, capable of providing signal transmission between the information component and the mobile communication apparatus.

2. Description of the prior art

Mobile communication apparatuses in the present market conditions, such as mobile phones, personal digital assistants, or notebooks, need to have information components installed to provide information for starting and operating the mobile communication apparatuses. For example, the general mobile phone needs to have a subscriber identity module (SIM) card installed to start the mobile phone and use the normal functions of the mobile phone, and the mobile phone can only dial some emergency numbers without the SIM card.

Please refer to FIG. 1. FIG. 1 is a schematic diagram illustrating a mobile communication apparatus 1 in the prior arts. As shown in FIG. 1, the connection of the information component 10 and the mobile communication apparatus 1 is often achieved by the information component connector 12, which is capable of electrically contacting the information component 10, configured on the mobile communication apparatus 1. However, because the information component connector 12 is configured on the mobile communication apparatus 1, the thickness of the mobile communication apparatus 1 would be limited by the information component connector 12. Furthermore, the printed circuit board of the mobile communication apparatus 1 is partially exposed from the casing at the position of the information component connector 12, and it influences the appearance of the mobile communication apparatus 1 and may cause damage to the printed circuit board and the mobile communication apparatus 1 by accident.

In the prior arts, the Taiwan patent with Patent Number 531,116 has disclosed a mobile phone capable of switching between at least two SIM cards. However, the thickness of the mobile phone is limited by the switching module and the SIM card connector. The Taiwan patent with Patent Number 468,899 has disclosed a combining SIM structure configured on the mobile phone and separated from the battery, therefore, the thickness of the mobile phone is still limited by the combining SIM structure.

Furthermore, the positions of the information component connector of some mobile communication apparatus are not set between the mobile communication apparatus and the battery, so the hot-plugging of the information component might occur by negligence when changing the information component. Hot-plugging might occur in the general mobile phone as shown in FIG. 1 by accident causing damage of the information component.

### SUMMARY OF THE INVENTION

Therefore, a scope of the invention is to provide a battery for providing the signal transmission between the information component and the mobile communication apparatus.

According to an embodiment, the battery of the invention could be installed in a mobile communication apparatus, and it comprises a contacting portion and a connecting portion. The contacting portion comprises a plurality of first conductive terminals for electrically contacting to an information component, and the connecting portion comprises a plurality of second conductive terminals for electrically contacting to the mobile communication apparatus. Particularly, at least one part of the second conductive terminals connects to the first conductive terminals to enable the information component to transmit a signal to the mobile communication apparatus through the first conductive terminals and the at least one part of the second conductive terminals. According to an embodiment, another part of the second conductive terminals could be used for providing the mobile communication apparatus with electrical power. Therefore, in addition to providing electrical power to the mobile communication apparatus, the battery of the invention can provide signal transmission between the information component and the mobile communication apparatus.

Another scope of the invention is to provide a mobile communication apparatus comprising a battery capable of providing the signal transmission between the information component and the mobile communication apparatus.

According to an embodiment, the mobile communication apparatus of the invention comprises a battery, and the battery further comprises a contacting portion and a connecting portion. The contacting portion comprises a plurality of first conductive terminals for electrically contacting to an information component, and the connecting portion comprises a plurality of second conductive terminals for electrically contacting to the mobile communication apparatus. At least one part of the second conductive terminals connect to the first conductive terminals to enable the information component to transmit a signal to the mobile communication apparatus through the first conductive terminals and the at least one part of the second conductive terminals. Furthermore, according to an embodiment, another part of the second conductive terminals could be used for providing the mobile communication apparatus with electrical power.

The advantage and spirit of the invention may be understood by the following recitations together with the appended drawings.

### BRIEF DESCRIPTION OF THE APPENDED DRAWINGS

FIG. 1 is a schematic diagram illustrating a mobile communication apparatus in the prior arts.

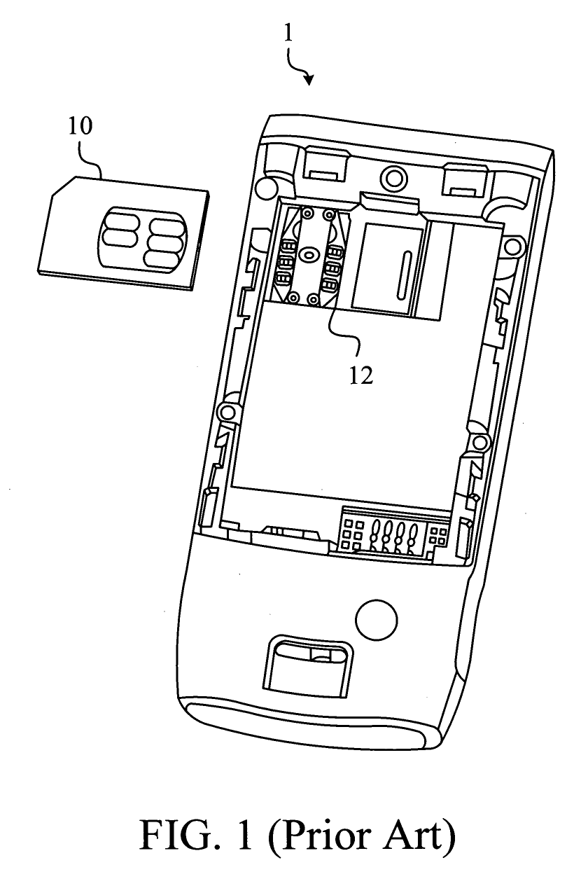

FIG. 2A is a schematic diagram illustrating the battery according to an embodiment of the invention.

FIG.2B is a schematic diagram illustrating a mobile communication apparatus according to another embodiment of the invention.

FIG. 2C is a schematic diagram illustrating that the mobile communication apparatus, the battery, and the information component connect to each other according to another embodiment of the invention.

### DETAILED DESCRIPTION OF THE INVENTION

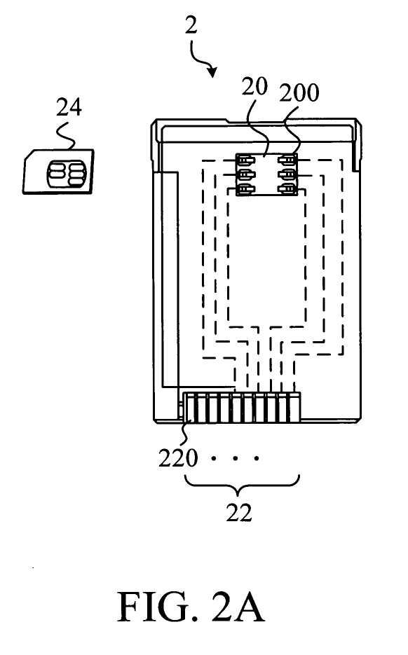

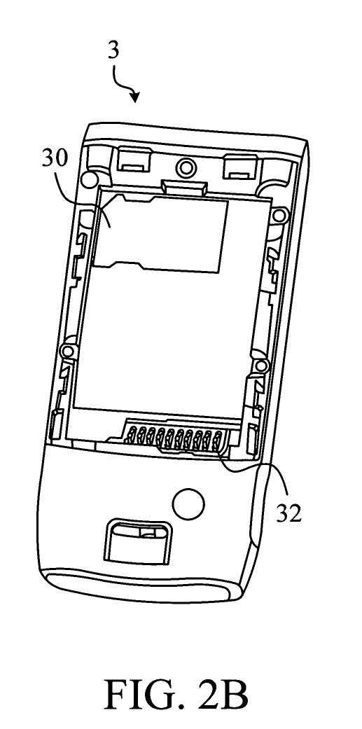

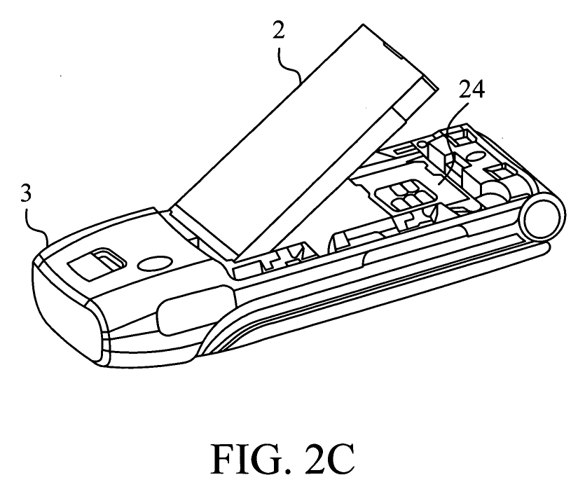

Please refer to FIG. 2A. FIG. 2A is a schematic diagram illustrating a battery 2 according to an embodiment of the invention. Particularly, the battery 2 could be used in the mobile communication apparatus, such as the mobile phone, the personal digital assistant (PDA), or the smart phone in practice.

As shown in FIG. 2A, the battery 2 comprises a contacting portion 20 and a connecting portion 22. The contacting portion 20 comprises a plurality of first conductive terminals 200 for electrically contacting to the information component 24. The connecting portion 22 comprises a plurality of second conductive terminals 220 for electrically contacting to the mobile communication apparatus, wherein, at least one part of the second conductive terminals 220 electrically connects to the first conductive terminals to enable the information component 24 to communicate with the mobile communication apparatus through the first conductive terminals 200 and the at least one part of the second conductive terminals 220.

In this embodiment, the battery 2 further comprises a power storing component (not shown in the figure), and the power storing component can electrical connect to another part of the second conductive terminals 220 that do not connect to the first conductive terminals 200. The power storing component can provide the mobile communication apparatus with electrical power through the another part of the second conductive terminals 220.

Furthermore, the contacting portion 20 of the battery 2 could further be provided with a fixing structure (not shown in the figure) for fixing the information component 24 on the contacting portion 20 in practice. The fixing structure could be, but not limited to, the plug-in type fixing structure for changing different information components. It should be noted that because the information component 24 is fixed on the battery 2 and the information components 24 proceeds during the battery 2 which stops providing electrical power, the hot-plugging could be avoided.

Please refer to FIG. 2A and FIG. 2B together. FIG. 2B is a schematic diagram illustrating a mobile communication apparatus 3 according to another embodiment of the invention. As shown in FIG. 2B, the mobile communication apparatus 3 comprises a containing area 30 and a plurality of first contacting points 32. The containing area 30 has a surface with no openings thereon, in other words, the mobile communication apparatus 3 has no openings partially exposing the printed circuit board (not shown in the figure) from the casing, so that the printed circuit board of the mobile communication apparatus 3 could be protected from damage by accident. Each of the first contacting points 32 can electrically contact one of the second conductive terminals 220 of the battery 2.

The difference between this embodiment and the last embodiment is that the contacting portion 20 the battery 2 in this embodiment has no fixing structure for fixing the information component 24. However, the containing area 30, corresponding to the contacting portion 20 of the battery 2, of the mobile communication apparatus 3 has a plug-in type fixing structure (not shown in the figure) for replaceably fixing the information component 24. When the mobile communication apparatus 3 fixes the information and connects to the battery 2 (as shown in FIG. 2C), the information component 24 electrically contacts the first conductive terminals 200 of the contacting portion 20, and the second conductive terminals 220 of the connecting portion 22 of the battery 2 electrically contact the first contacting points 32 of the mobile communication apparatus 3. It should be noted that the electrical contacts between the information component 24 and the first conductive terminals 200 and between the second conductive terminals 220 and the first contacting points 32 are one-to-one contacts. Accordingly, the information component 24 can transmit signals to the mobile communication apparatus 3 through the first conductive terminals 200, the second conductive terminals 220 connecting to the first conductive terminals 200, and the corresponding first contacting points 32. The power storing component of the battery 2 can provide the mobile communication apparatus 3 with electrical power through the second conductive terminals 220, which do not connect to the first conductive terminals 200, and the corresponding first contacting points 32.

Practically, the above information component 24 could be, but not limited to, a subscriber identity module (SIM) card or a user identity module (UIM) card.

Compared to the prior art, the information component can connect to and communicate with the mobile communication apparatus through the conductive terminals of the battery of the invention. The information component indirectly connects to the mobile communication apparatus, and therefore, it is not necessary for configuring the information component connector, limiting the thickness of the mobile communication, on the mobile communication apparatus. Furthermore, the casing of the mobile communication apparatus does not need any opening to partially expose the printed circuit board, and then the printed circuit board is protected from damage by accident. The information component could be avoided form hot-plugging due to electrically contacting the battery directly.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A battery, configured in a mobile communication apparatus, the battery comprising:
a contacting portion, comprising a plurality of first conductive terminals for electrically contacting to a information component; and
a connecting portion, comprising a plurality of second conductive terminals for electrically contacting to the mobile communication apparatus, wherein at least one part of the second conductive terminals connecting to the first conductive terminals to enable the information component to transmit a signal to the mobile communication apparatus through the first conductive terminals and the at least one part of the second conductive terminals.

2. The battery of claim 1, further comprising a power storing component, the power storing component electrically connecting to another part of the second conductive terminals to provide the mobile communication apparatus with electrical power.

3. The battery of claim 1, wherein the contacting part has a fixing structure for fixing the information component on the contacting part.

4. The battery of claim 3, wherein the fixing structure is a plug-in type fixing structure.

5. The battery of claim 1, wherein the mobile communication apparatus further comprises a containing area for containing the information component.

6. The battery of claim 5, wherein the containing area of the mobile communication apparatus has a surface without openings.

7. The battery of claim 5, wherein the containing area has a fixing structure for fixing the information component in the containing area.

8. The battery of claim 7, wherein the fixing structure is a plug-in type fixing structure.

9. The battery of claim 1, wherein the information component is a subscriber identity module card or a user identity module card.

10. The battery of claim 1, wherein the mobile communication apparatus is a mobile phone, a personal digital assistant, or a smart phone.

11. A mobile communication apparatus, comprising:
a battery, comprising:
a contacting portion, comprising a plurality of first conductive terminals for electrically contacting to a information component; and
a connecting portion, comprising a plurality of second conductive terminals for electrically contacting to the mobile communication apparatus, wherein at least one part of the second conductive terminals connecting to the first conductive terminals to enable the information component to transmit a signal to the mobile communication apparatus through the first conductive terminals and the at least one part of the second conductive terminals.

12. The mobile communication apparatus of claim 11, wherein the battery further comprises a power storing component, and the power storing component electrically connects to another part of the second conductive terminals to provide the mobile communication apparatus with an electrical power.

13. The mobile communication apparatus of claim 11, wherein the contacting part has a fixing structure for fixing the information component on the contacting part.

14. The mobile communication apparatus of claim 13, wherein the fixing structure is a plug-in type fixing structure.

15. The mobile communication apparatus of claim 11, further comprising a containing area for containing the information component.

16. The mobile communication apparatus of claim 15, wherein the containing area has a surface without openings.

17. The mobile communication apparatus of claim 15, wherein the containing area has a fixing structure for fixing the information component in the containing area.

18. The mobile communication apparatus of claim 17, wherein the fixing structure is a plug-in type fixing structure.

19. The mobile communication apparatus of claim 11, wherein the information component is a subscriber identity module card or a user identity module card.
